(19) United States
(12) Patent Application Publication
(10) Pub. No.: US 2009/0058603 A1
(43) Pub. Date: Mar. 5, 2009

(54) Rfid Reading Apparatus and Method

(75) Inventors: Heikki Seppa, Helsinki (FI); Timo Varpula, Vantaa (FI); Pekka Pursula, Espoo (FI); Mikko Kiviranta, Espoo (FI)

Correspondence Address: BIRCH STEWART KOLASCH & BIRCH, PO BOX 747, FALLS CHURCH, VA, 22040-0747, US

(73) Assignee: Valtion Teknillinen Tutkimuskeskus, Espoo (FI)

(21) Appl. No.: 11/988,241

(22) PCT Filed: Jun. 20, 2006
(86) PCT No.: PCT/FI2006/000219

§ 371 Date: Jul. 21, 2008

(51) Int. Cl. H04Q 5/22

(52) U.S. Cl. 340/10.1

(57) ABSTRACT

This publication discloses an RFDD reading apparatus (1) and a method for the reading apparatus. The RFID reading apparatus comprises a transmitter (3), which is arranged to feed power to at least one RFED tag (2) in the vicinity of the RFID reading apparatus (1), and a receiver (4) operating on the frequency of the transmitter (3), so that the transmitter (3) and the receiver (4) are in operation simultaneously and the receiver (4) is arranged to receiver through a radio channel (7) a reflected signal of at least one RFDD tag (2) in the vicinity of the reading device. In accordance with the invention, the RFDD reading apparatus (1) comprises additionally means (Z2, 12, 13, 14, 20) for separating the payload signal arriving from the RFDD tag (2) from signals other than those arriving from the RFDD tag (2).

The present invention relates to an RFID reading apparatus according to the preamble of claim 1.

The invention also relates to an RFID reading method.

According to the prior art, in wireless transmitter-receivers, transmission and reception between the transmitter and receiver have traditionally been separated from each other, either on the frequency level or on the time level. In other words, if at least more or less simultaneous transmission and reception take place, the reception is implemented, relative to the transmission, on a different frequency, or the transmission and reception are temporally overlapped separately from each other.

In RFID methods, passive RFID elements (RFID tags) are used as the receiving elements in mass applications. These receiving elements get their operating energy from the transmission power of the reading device while the return signal is based on modulation of the tag's backscattering. On account of the power supply, the transmission should be continuous. In an RFID device, both the transmitter and the receiver operate on the same frequency, so that the transmission and the reception cannot be separated from each other on either the frequency level or the time level. The payload signal arriving at the transmitter is a reflection of the transmission signal, modulated by the tag. On account of the internal circuitry of the reading device, the transmission signal is connected to some extent undesirably to the reception signal while, in addition to this, undesirable backscattering from the environment of the reading device occur and the internal and external backscattering increase the signal arriving at the receiver. This excess signal, caused by environmental backscattering and the internal circuitry of the reader—a so-called direct coupling—loads the RF front end of the receiver and often takes it away from the linear range, which in turn may, in the worst cases, radically weaken the amplification of the payload signal. In practice, this technical problem is realized as an uncertain reading event and also as a reduction in reading distance.

The invention is intended to eliminate the defects of the prior art disclosed above and for this purpose create an entirely new type of RFID reading apparatus and reading method.

The invention is based on forming a compensation channel in parallel with the normal radio channel between the tag and the reading device, with the aid of the set or measured parameters of which it is possible to attenuate the signal of the undesired direct coupling contained in the received signal.

More specifically, the apparatus according to the invention is characterized by what is stated in the characterizing portion of claim 1.

The method according to the invention is, in turn, characterized by what is stated in the characterizing portion of claim 9.

Considerable advantages are gained with the aid of the invention.

The invention also has preferred embodiments, by means of which the device's internal circuitry and external backscattering can be effectively attenuated. With the aid of the invention, the reading event becomes more reliable, while the reading distance can also be increased. Particularly good results are obtained with the aid of the embodiments of the invention in environments, in which there are many surfaces, such as metal surfaces, reflecting the transmission power.

In the following, the invention is examined with the aid of examples and with reference to the accompanying drawings.

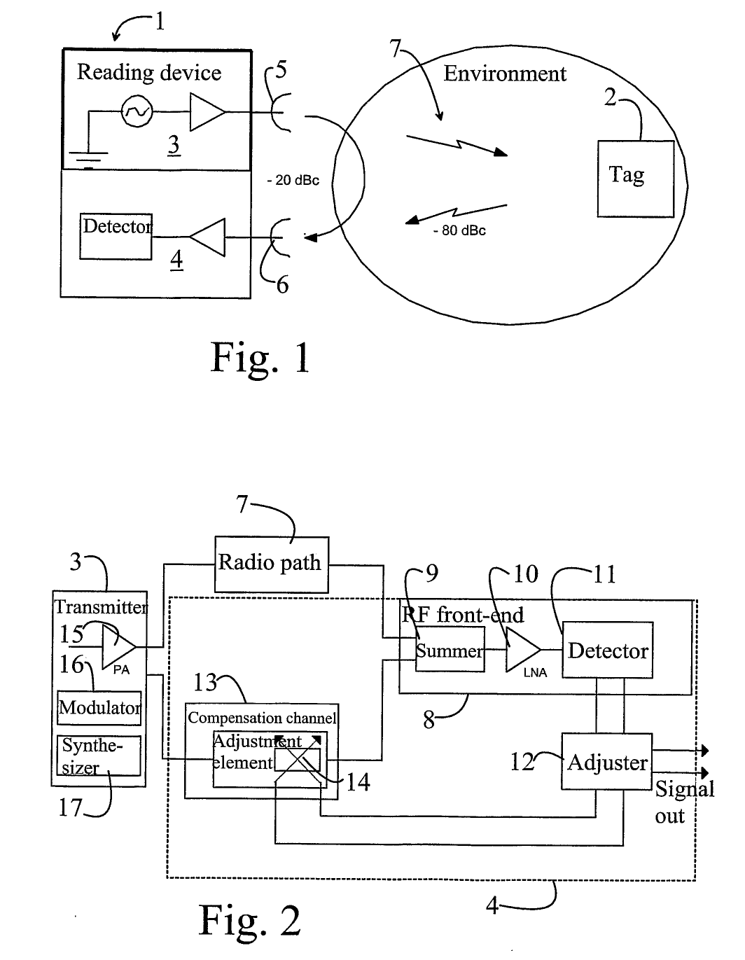

FIG. 1 shows one measuring environment applicable to the method according to the invention.

FIG. 2 shows a block diagram of one general solution according to the invention.

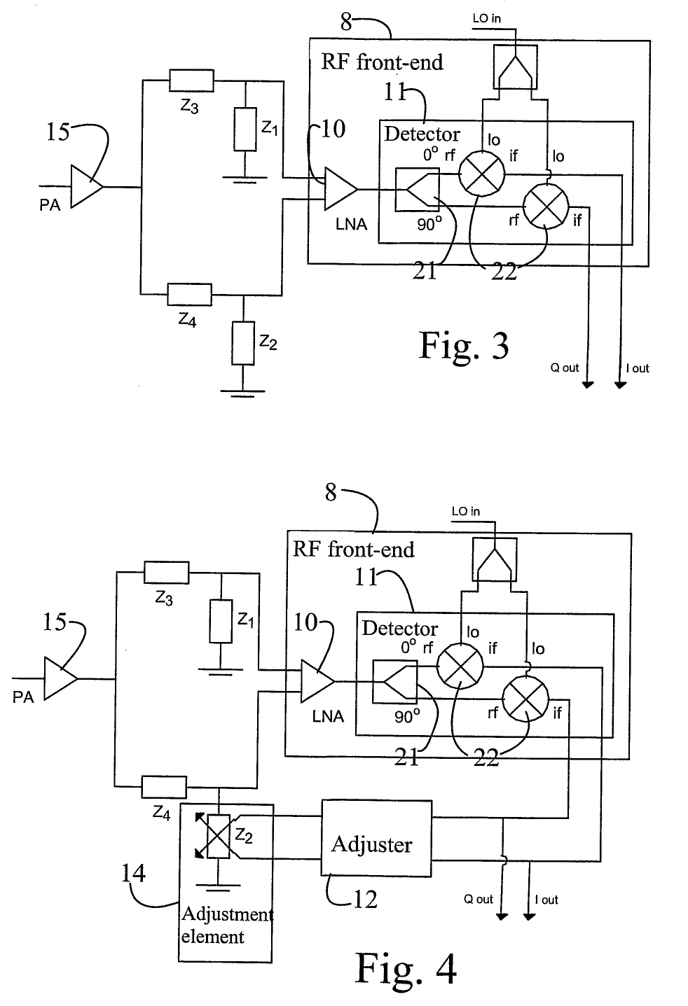

FIG. 3 shows a block diagram of a special solution according to the invention of FIG. 2.

FIG. 4 shows a block diagram of a second special solution according to the invention of FIG. 2.

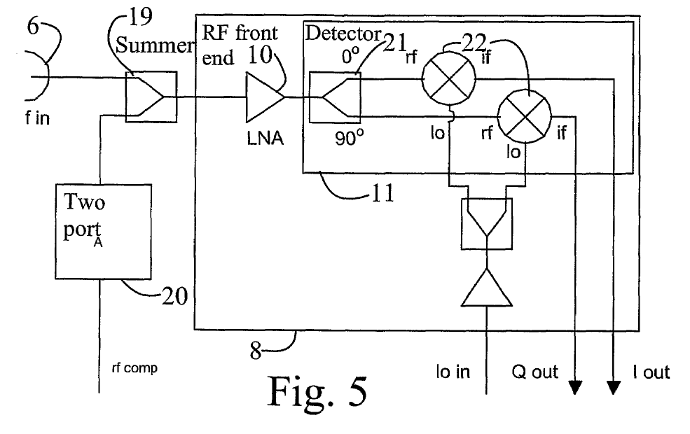

FIG. 5 shows a block diagram of a third special solution according to the invention of FIG. 2.

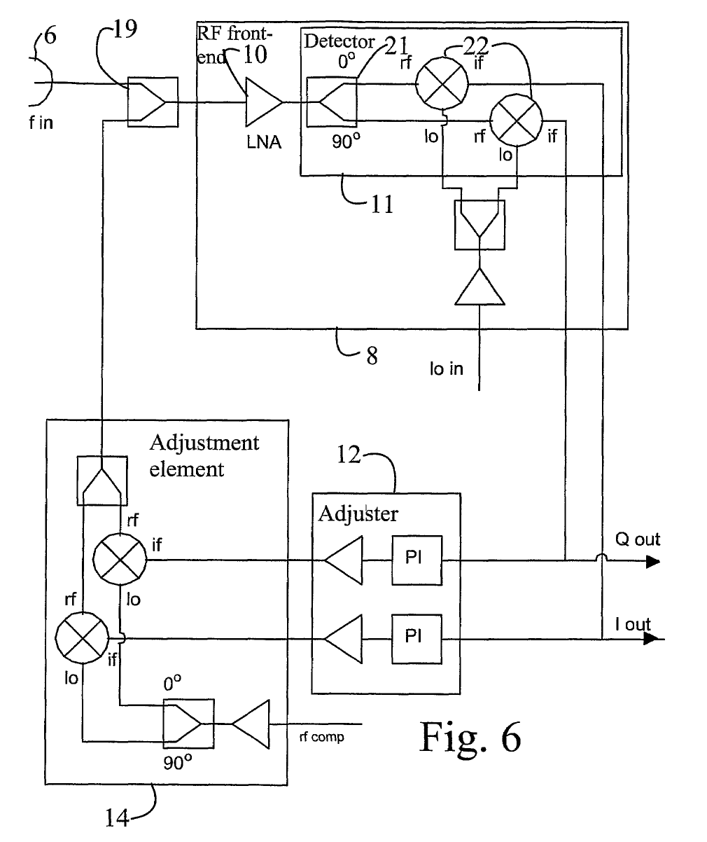

FIG. 6 shows a block diagram of a special solution according to the invention of FIG. 2.

In the following description, the following terminology will be used:
RFIS reading device 1
RFID tag 2
Transmitter of RFID reading device 3
Receiver of RFID reading device 4
Transmission antenna 5
Reception antenna 6
Transfer path 7
RF front-end of receiver 8
First summer 9
Low-noise preamplifier (LNA) 10
Detector 11
Adjuster 12
Compensation/reference channel 13
Adjusting element 14
Power amplifier (PA) of transmitter 15
Modulator 16
Synthesizer 17
Second summer 19
Two port 20
90-degree power divider 21
Mixer 22

According to the solution shown in FIG. 1, in remote-detector technology (RFID) data transfer from the tag 2 (RFID detector) is based on modulation of the backscattering of the tag 2. The tag thus reflects the signal sent by the transmitter device 1 as a modulated signal. Details (product type, packing date, object, etc.) relating to the identity of the tag 2, or possibly data (humidity, pressure, temperature, etc.) of a sensor integrated with the tag, are typically received from the tag 2 in the reading event. Due to the manner of communication, in the reading device 1, both the transmitter 3 and the receiver 4 are simultaneously switched on, because the reading device should at the same time supply power to the tag 2 to ‘wake it up’ for operation. In addition, both the transmitter 3 and the receiver 4 operate on the same frequency, in which case direct coupling to the receiver 4 is difficult to avoid.

The coupling of the signal from the transmitter to the receiver is quite large relative to the payload signal reflected from the tag.

This direct coupling is due to both the internal circuitry of the reader and backscattering from the environment. In normal environments, the magnitude of the coupling can rise to −20 dBc, whereas the payload signal, which it is intended to detect, can be in the order of magnitude of −80 dBc, or even smaller. The large direct coupling can saturate the sensitive front-end of the receiver 4, in which case the payload signal will not be detected.

The general solution, according to the invention, for eliminating backscattering is shown at a block-diagram level in FIG. 2. The RFID transmitter 3 typically comprises a power amplifier 15, a modulator 16, and a synthesizer 17. The signal of the transmitter 3 couples to the receiver 4, both inside the reader and through environmental backscattering. In addition to this coupling, the radio path 7 of FIG. 2 contains the payload signal from the tag 2. The RF signal caused by direct coupling is removed from the signal transferred to the detector with the aid of a reference or correction signal produced in the compensation channel. The compensation signal is formed of either the output signal of the PA 15, or from some other rf signal. Removal takes place with the aid of the first summer 9 and an asymmetrical preamplifier, or a differential amplifier (which includes a summer element). A low-frequency signal is taken from the detector 11 or the adjuster 12. In the adjuster 12 is, in turn, used to control the adjusting element 14 of the compensation channel 13, in order to compensate for the undesired signal coupled from the transmitter 3, and thus to separate the undesired signals of the output signal returning from the tag.

FIG. 3 shows a simple solution to the direct-coupling problem. At its simplest, the solution is a passive bridge coupling, in which the same signal is fed to both the TX/RX antennae and to the artificial load, i.e. the reference impedance. In the figure, the impedance Z₁ depicts the antenna and Z₂ depicts the reference impedance, i.e. the artificial load. The resistances Z₃ and Z₄ depict either real resistances or the specific impedances of the transfer path. In the bridge coupling, a differential amplifier is used as the preamplifier 10, which amplifies the separation of the signals arriving at its inputs. Thus, the amplitude of the reference signal arriving at the preamplifier 10 through the artificial load Z₂ should be equal to and in phase with the undesired signal arriving from the antenna, so that the direct coupling will be cancelled. By using this solution it is possible to remove a constant component of the coupling, such as the internal coupling of the device.

Because the environment is dynamic, the direct coupling too changes. For this reason, it is advantageous to adjust the reference signal.

FIG. 4 shows the use of a bridge coupling to eliminate a varying coupling. Such varying undesirable couplings are caused in the reading situation mainly moving surfaces, such a metal surfaces, reflecting radio-frequency transmission energy. In the figure, the impedance Z₁ depicts the antenna and the impedance Z₂ depicts the artificial load, from the complex of which the impedance can be regulated using two (orthogonal) parameters. The adjusting elements 14 can be, for example, a PIN diode (the real component of the impedance) and a varactor (the imaginary component of the impedance). These elements are connected, for example, in parallel to ground. The regulation of the element 14 takes place using the adjuster 12, which in turn receives its control signal from the detector 11 connected after the amplifier 10. The detector 11 can be, for example, a conventional quadrature detector, which comprises a 90-degree power divider 21, which separates the zero-phase component of the signal of the output of the amplifier 10 from the orthogonal signal relative to this, which represents the imaginary component of the signal and the mixers 22, by means of which the radio-frequency signal is dropped to the carrier-wave frequency, by multiplying by a signal by, for example the frequency of a local oscillator.

In the bridge couplings of both FIG. 3 and of FIG. 4, the detection of the signal and the elimination of the coupling are based on comparing the impedance of the antenna to an impedance Z₂. If the impedances Z₁ and Z₂ are of different magnitude, the signals in the inputs of the differential amplifier will also be different. If the reference impedance Z₂ is regulated, the inputs of the differential amplifier can be held to the same values in the same regulation band, in which case the input signal of the rf front-end in the regulation band will remain small.

Instead of a bridge coupling, the direct coupling can also be eliminated according to FIG. 5 by actively producing a correction signal. In FIG. 5, this is implemented with the aid of an asymmetrical preamplifier. In that case, the signal compensating backscattering is brought to the input of the preamplifier through a second summer element 19. The correction signal now has an amplitude of the same magnitude as the undesired signal coming from the antenna, but has an opposite phase. The two port A 20 is designed in such a way that the compensation signal coupled in front of the preamplifier 10 cancels the signal caused by the direct coupling, so that the signal transferred to the input of the preamplifier will remain small.

A better result is again achieved by actively regulating the correction signal in two (orthogonal) stages, according to FIG. 6. In this circuit, the correction signal is regulated actively as a function of the detected coupling. The regulation ensures that the signal transferred to the preamplifier 10 will remain sufficiently small, when the coupling changes on account of a change in the environment. The detector 11 of FIGS. 3, 5, and 6 acts as described in connection with FIG. 4.

The following variations can also be envisaged within the scope of the invention: Within the scope of the invention, the RF front-end can also be implemented without a preamplifier. In that case, the signal arriving from the antenna to the receiver is coupled to a (differential or asymmetrical) detector, either directly or through an attenuator.

Bridge methods (FIGS. 3 and 4):
The RX/TX antenna can be coupled to the bridge, either directly or through a circulator. To reduce power loss, transformers can be added to the bridge couplings, which will reduce the current of the artificial load branch, without altering the functionality of the circuit.
The frequency band of the adjuster can be either below the information band or above the entire information band.
Instead of a differential preamplifier, a summer element and asymmetrical preamplifier can be used. The phase of the reference signal should then be inverted.

Correction signal methods (FIGS. 5 and 6).
The reading device can be implemented using either a single antenna with the aid of a circulator, or using separate RX and TX antennae.
Other active elements, such as mixers, for example PIN diodes, can be used as the adjusting elements for the correction signal, in which case the correction signal may have to be regulated in more than two stages.
The frequency band of the adjuster can be either under the information band or above the entire information band.
The correction signal methods can also be implemented using a differential amplifier, in which case the correction signal is fed without a summer to the second input of the differential amplifier. In that case, the stage of the compensation signal must be inverted.
Either the output of the transmitter, the synthesizer of the transmitter, or some other rf source can be used as the rf source (rf comp) of the correction signal.

1. RFID reading apparatus (1), which comprises
a transmitter (3), which is arranged to feed power to at least one RFID tag (2) in the vicinity of the RFID reading apparatus (1), and
a receiver (4) operating on the frequency of the transmitter (3), so that the transmitter (3) and the receiver (4) are generally in operation simultaneously and the receiver (4) is arranged to receive through a radio channel (7) a reflected signal of at least one RFID tag (2) in the vicinity of the reading device,
characterized in that, the RFID reading apparatus (1) comprises in addition
means (Z₂, 12, 13, 14, 20) for separating the payload signal arriving from the RFID tag (2) from signals other than those arriving from the RFID tag (2).

2. RFID reading apparatus (1) according to claim 1, characterized in that it comprises an artificial load or reference impedance (14, Z₂) for separating the payload signal arriving from the RFID tag (2) from signals other than those arriving from the RFID tag (2).

3. RFID reading apparatus (1) according to claim 2, characterized in that the artificial load or reference impedance (14, Z₂) is adjustable.

4. RFID reading apparatus (1) according to claim 3, characterized in that the apparatus comprises means (12) for adjusting the artificial load or reference impedance (14, Z₂) during operation.

5. RFID reading apparatus (1) according to claim 1, 2, 3, or 4, characterized in that the artificial load or reference impedance (14, Z₂) is located to be part of a bridge coupling.

6. RFID reading apparatus (1) according to claim 1, characterized in that the receiver is coupled to separate the payload signal arriving from the RFID tag (2) from signals other than those arriving from the RFID tag (2).

7. RFID reading apparatus (1) according to claim 6, characterized in that the correction signal is adjustable.

8. RFID reading apparatus (1) according to claim 6, characterized in that the apparatus comprises means (12) for regulating the correction signal.

9. RFID reading method, in which method
to an RFID tag (2) is fed power over a radio link (7) in order to create operating energy for the RFID tag (2) and for creating reception for the return reflection signal,
the signal reflected by the RFID tag (2) is received and detected,
characterized in that
signals other than those reflected by the RFID tag (2) are defined and attenuated in order to separate the returning payload signal from the RFID tag (2) from other signals.

10. RFID reading method according to claim 9, characterized in that an artificial load or reference impedance (14, Z₂) is used in order to separate the payload signal arriving from the RFID tag (2) from signals other than those arriving from the RFID tag (2).

11. RFID reading method according to claim 10, characterized in that the artificial load or reference impedance (14, Z₂) are regulated during operation.

12. RFID reading method according to claim 9, 10, or 11, characterized in that the artificial load or reference impedance (14, Z₂) is situated as part of the bridge coupling.

13. RFID reading method according to claim 9, characterized in that a correction signal is used in the receiver, in order to separate the payload signal arriving from the RFID tag (2) form signals other than those arriving from the RFID tag (2).

14. RFID reading method according to claim 13, characterized in that the correction signal is regulated during operation.
